(19) United States
(12) Patent Application Publication
(10) Pub. No.: US 2026/0146639 A1
(43) Pub. Date: May 28, 2026

(54) FASTENER FOR AN AIRBAG

(71) Applicant: A. RAYMOND ET CIE, Grenoble (FR)

(72) Inventors: James M. Mell, Chesterfield, MI (US); Dheerendra M. Sridhar, Rochester Hills, MI (US); Alex M. Langreet, Oakland, MI (US)

(21) Appl. No.: 19/177,836

(22) Filed: Apr. 14, 2025

Related U.S. Application Data
(60) Provisional application No. 63/634,629, filed on Apr. 16, 2024.

(51) Int. Cl. F16B 37/04; F16B 5/06

(52) U.S. Cl. CPC F16B 37/043; F16B 5/0642

(57) ABSTRACT

A fastener for an airbag is provided. The fastener includes a body having a head, sidewalls extending longitudinally from the head and defining a void space within the body, and at least one slot formed in the sidewalls. A receiving hole is formed in the head. A carrier is disposed within the void space of the head. The carrier includes at least one control arm corresponding to the at least one slot, each control arm terminating in a retention clamp. An actuator is retained at the receiving hole of the head and engaged with the carrier. The actuator is reversibly operable to freely move the carrier between a first position in which each retention clamp is retracted within the void space of the body and a second position in which each retention clamp extends outwardly through one of the at least one slot in the body. A method of attaching a component to a panel including an aperture is also provided.

### CROSS REFERENCE TO RELATED APPLICATIONS

This application claims the benefit of U.S. Provisional Application No. 63/634,629, filed Apr. 16, 2024, the disclosure of which is incorporated by reference in its entirety.

### FIELD OF THE INVENTION

The disclosure generally relates to fasteners for attaching a component to a panel and, more specifically, to fasteners for application to an airbag of a vehicle.

### BACKGROUND OF THE INVENTION

It is known to attach a fastener to a panel so that another component can be joined with the panel. For example, in certain applications such as to mount an airbag to a panel, a welded nut is used. Other fasteners have a more complex design, but the clamping load is not provided by a screwing torque. Thus, the clamping force provided by conventional fasteners may not be adequate to maintain the installation of the fastener and component on the panel. Additionally, in order to service the fastener and/or the component attached by the fastener, typical fasteners cannot be dismounted and removed without damage to the panel or component, or without leaving part of the fastener on the panel. Therefore, there remains room for improvement in the field of fasteners to maintain effective and adequate installation of the fasteners on panels and to provide ease of service should the fastener need to be removed.

### BRIEF SUMMARY

An improved fastener for attaching a component to a panel is provided. The fastener includes a body. The body including a head, sidewalls extending longitudinally from the head and defining a void space within the body, and at least one slot formed in the sidewalls. A receiving hole is formed in the head. A carrier is disposed within the void space of the head. The carrier includes at least one control arm corresponding to the at least one slot, each control arm terminating in a retention clamp. An actuator is retained at the receiving hole of the head, and the actuator is engaged with the carrier. The actuator is reversibly operable to freely move the carrier between a first position in which each retention clamp is retracted within the void space of the body and a second position in which each retention clamp extends outwardly through one of the at least one slot in the body.

In specific embodiments, the actuator is a leadscrew including a head and a threaded shaft, and the carrier includes a threaded collar that is mated with the threaded shaft.

In particular embodiments, the threaded shaft extends through the receiving hole of the head and is retained within the void space of the body.

In other specific embodiments, the actuator is a threaded nut, and the carrier includes a threaded shaft that is mated with the threaded nut.

In particular embodiments, the actuator is retained on an outer face surface of the head.

In specific embodiments, rotational movement of the actuator is translated into linear movement of the carrier.

In specific embodiments, the body includes at least one displacement control element cooperable with each control arm of the carrier.

In particular embodiments, the displacement control elements each include a ramp surface that is engageable with a respective one of the control arms.

In specific embodiments, each control arm includes a stop adjacent to the retention clamp. The stop restricts outward movement of the retention clamp through the slot.

In specific embodiments, the body includes at least one pre-assembly clip extending from the sidewall.

In particular embodiments, the at least one pre-assembly clip is a pair of opposite pre-assembly clips.

In specific embodiments, the at least one slot formed in the sidewalls is a pair of opposite slots, and the carrier includes a pair of the control arms, each control arm corresponding with one of the slots.

In particular embodiments, the at least one displacement control element is a pair of displacement control elements, each coopearble with one of the control arms of the carrier.

In specific embodiments, the head of the body includes a pair of opposite flanges extending laterally beyond a perimeter of the sidewalls.

In specific embodiments, the body, the carrier, and the actuator form a unitary assembly.

A method of attaching a component to a panel including an aperture is also provided. The method includes providing the fastener. The method further includes inserting the sidewalls of the body through the aperture in the panel such that the head is adjacent the aperture. The method further includes rotating the actuator in a first angular direction to move the carrier from the first position to the second position such that the retention clamps extend outwardly through the slots in the sidewalls and contact a surface of the panel opposite the head. The panel is thereby compressed between the head and the extended retention clamps, the fastener is fixed to the panel about the aperture, and torque of the actuator provides a clamping force to maintain the fixing of fastener to the panel.

In specific embodiments, the method further includes rotating the actuator in a second angular direction that is opposite the first angular direction to move the carrier from the second position to the first position such that the retention clamps are drawn back through the slots and into the void space within the sidewalls of the body. The body can then be removed from the aperture in the panel, whereby the fastener is reusable.

### DESCRIPTION OF THE DRAWINGS

Various advantages and aspects of this disclosure may be understood in view of the following detailed description when considered in connection with the accompanying drawings, wherein:

FIG. 1 is a perspective view of a fastener in accordance with embodiments of the disclosure;

FIG. 2 is a sectional view of the fastener of FIG. 1;

FIG. 3 is a perspective view of a body of the fastener of FIG. 1;

FIG. 4 is a schematic illustration of assembly of the fastener including insertion of a carrier of the fastener into the body;

FIG. 5 is a perspective view from below of the body and carrier of the fastener;

FIG. 6 is a schematic illustration of assembly of the fastener including insertion of an actuator of the fastener into the body;

FIG. 7 is a schematic illustration of the actuator partially inserted into the body, prior to threading the actuator onto the carrier;

FIG. 8 is a sectional view of the fully assembled fastener including an enlarged portion showing the fastener at an opening in a head of the body;

FIG. 9 is a schematic illustration of insertion of the fastener into an aperture of a panel;

FIG. 10 is a perspective view of the fastener inserted into the aperture of the panel;

FIG. 11 is a schematic illustration of movement of the carrier, via rotation of the actuator, from a first position to a second position in which control arms are moved outwardly to force retention clamps into engagement with the panel;

FIG. 12 is an enlarged, partial sectional view showing engagement of the control arm with a ramp surface of the body;

FIG. 13 is a perspective view from below of the fastener attached to the panel;

FIG. 14 is a schematic illustration of reverse movement of the actuator and the carrier to release the fastener from the panel;

FIG. 15 is a schematic illustration of outward movement of the fastener out of the aperture in the panel after release of the retention clamps from the panel;

FIG. 16 is an enlarged, partial perspective view of a fastener in accordance with some embodiments of the disclosure, the control arm of the carrier including stops;

FIG. 17 is an enlarged, partial perspective view of the carrier of FIG. 16;

FIG. 18 is a sectional view of a fastener in accordance with other embodiments of the disclosure;

FIG. 19 is a perspective view from above of the fastener of FIG. 18;

FIG. 20 is a side view of a fastener in accordance with yet other embodiments of the disclosure;

FIG. 21 is a sectional view of the fastener of FIG. 20;

FIG. 22 is a perspective view of the fastener of FIG. 20;

FIG. 23 is a side view of a fastener in accordance with yet other embodiments of the disclosure;

FIG. 24 is a sectional view of the fastener of FIG. 23;

FIG. 25 is a perspective view of the fastener of FIG. 23;

FIG. 26 is a perspective view of a fastener in accordance with yet other embodiments of the disclosure;

FIG. 27 is a sectional view of a body of the fastener of FIG. 26, as viewed from the side;

FIG. 28 is another sectional view of the body of the fastener of FIG. 26, as viewed from the top;

FIG. 29 is a perspective view of a carrier of the fastener of FIG. 26;

FIG. 30 is a perspective view of a fastener in accordance with yet other embodiments of the disclosure;

FIG. 31 is a side view of the fastener of FIG. 30;

FIG. 32 is an enlarged portion of the side view of FIG. 31, in which overlap of control arms of the carrier by a sidewall of the body is illustrated;

FIG. 33 is a perspective view of a fastener in accordance with yet other embodiments of the disclosure; and

FIG. 34 is a sectional view of the fastener of FIG. 33.

### DETAILED DESCRIPTION OF THE INVENTION

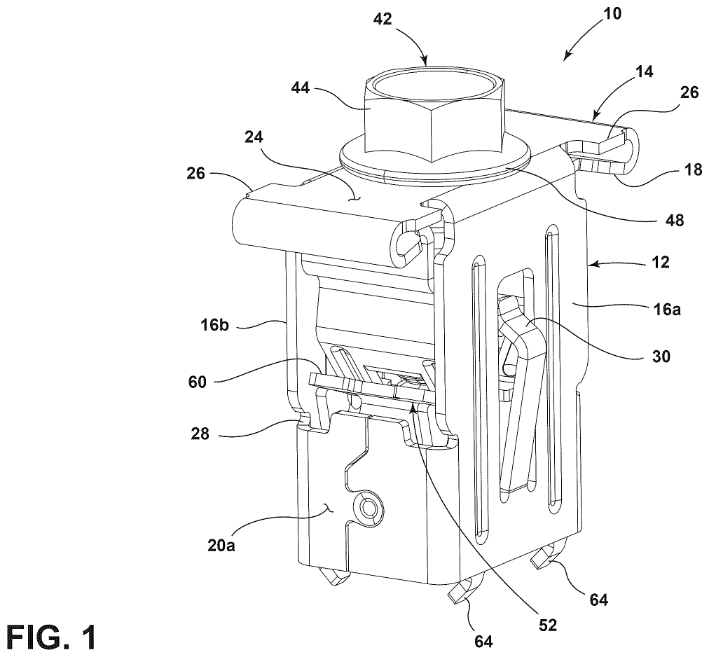

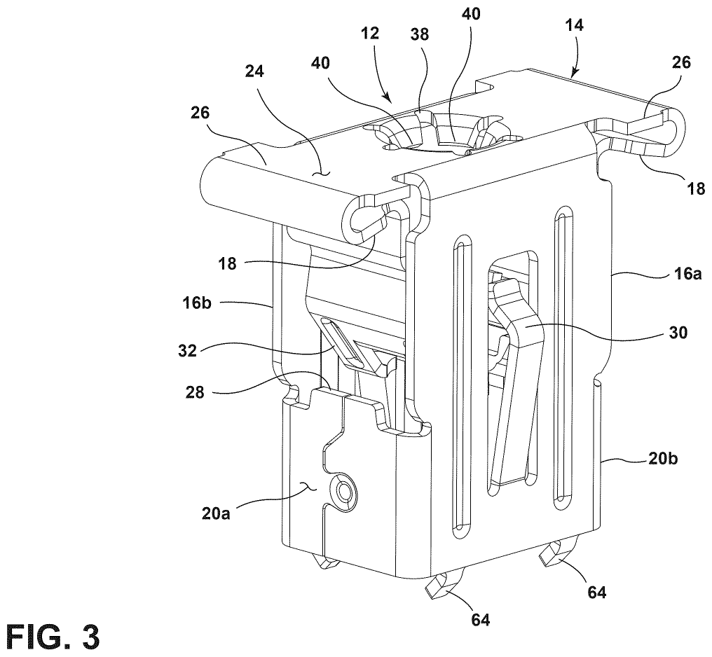

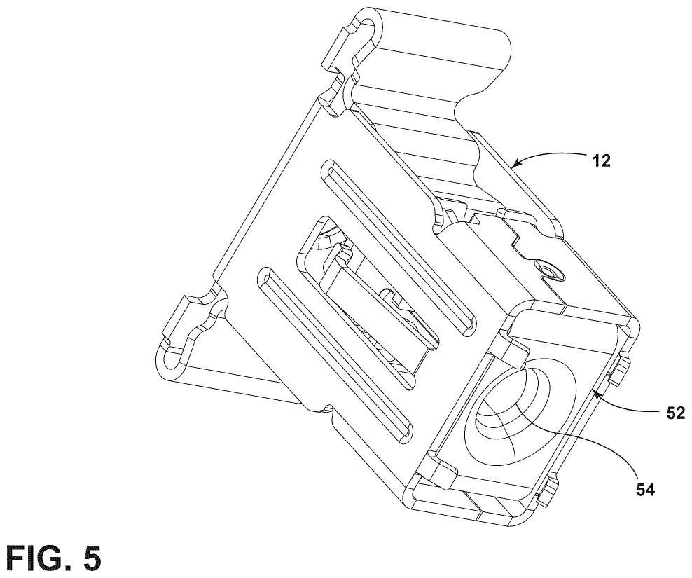

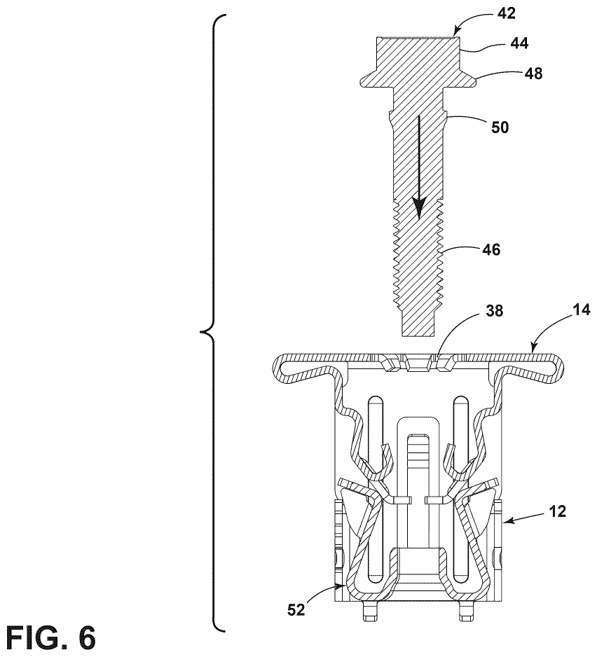

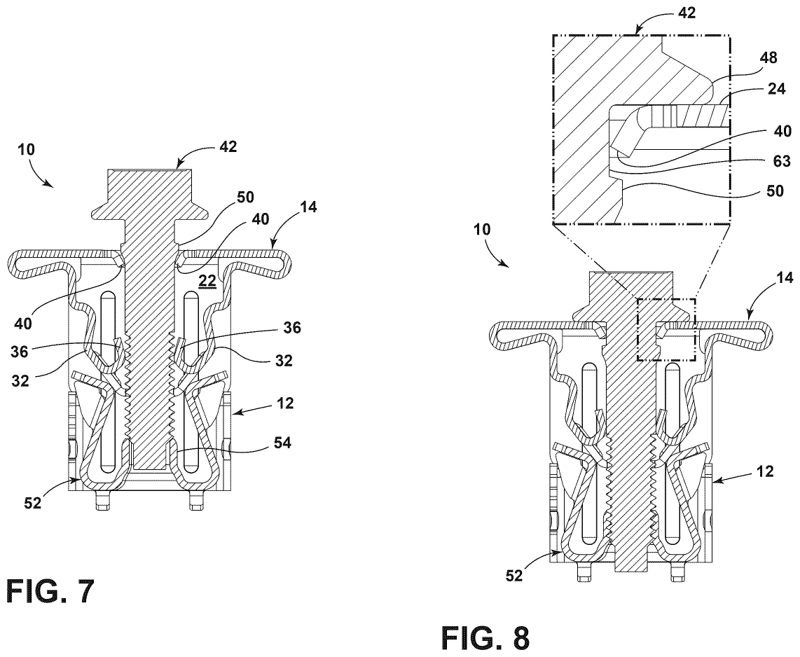

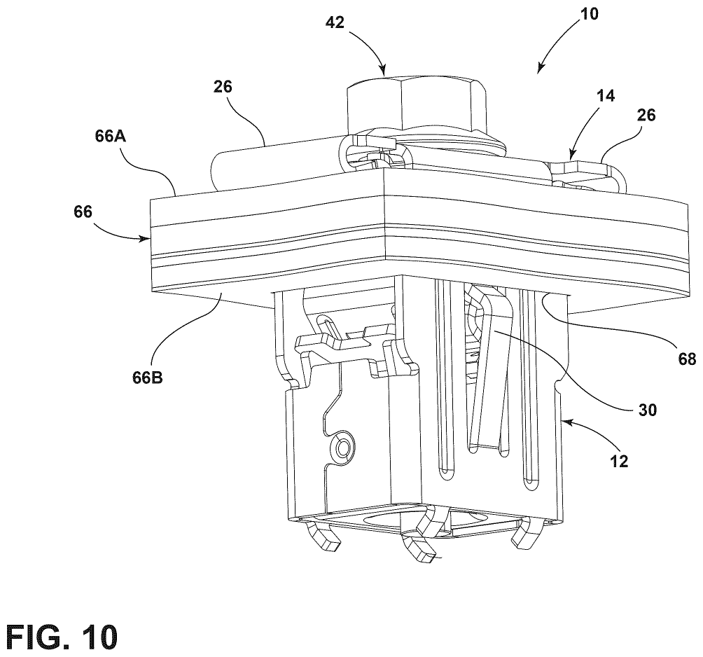

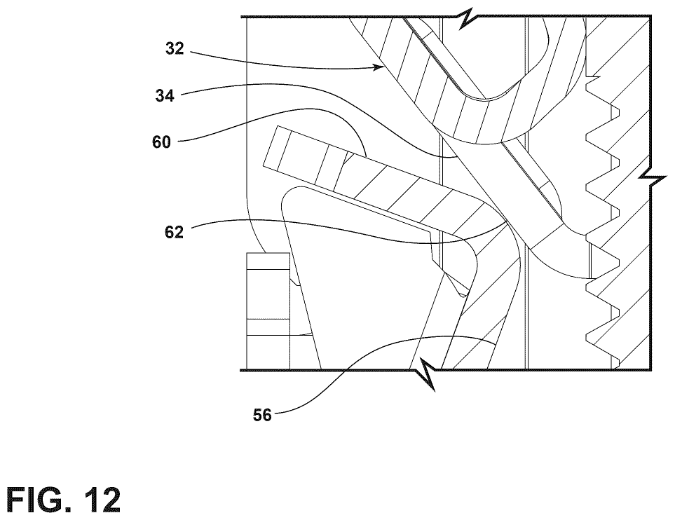

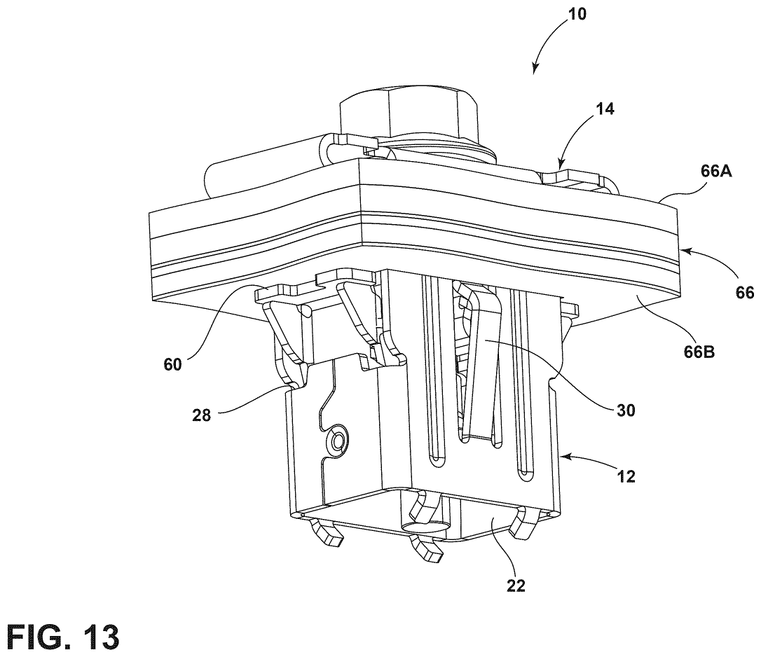

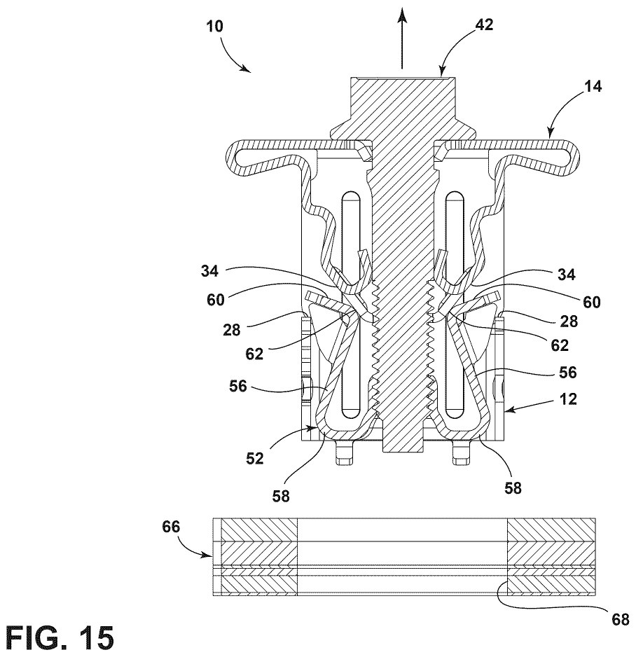

Referring to FIGS. 1-34, wherein like numerals indicate corresponding parts throughout the several views, the fastener is illustrated and generally designated at 10, 310, 410, 510, 610, 710. The fastener can be installed on a panel without the use of a separate nut on the panel surface. Instead, the fastener has an integral, deformable carrier that may function as the “nut” and that is embedded within the fastener. The carrier is activated with a screw that provides torque functioning as the clamping load that activates clamps on the carrier that secure the fastener to the panel. The fastener also can be uninstalled from the panel without damage to the fastener by reversing the turning force on the screw. In this manner, the fastener allows for easier serviceability when applied to a panel and subsequent reuse of the fastener. Certain features of the fastener are functional, but can be implemented in different aesthetic configurations.

With reference now to FIGS. 1-15, a first, exemplary embodiment of the fastener 10 is shown. The fastener 10 includes a body 12. The body 12 includes a head 14 that transitions into a pair of opposing sidewalls 16a, 16b via a curved and/or contoured portion 18 of the head. The body 12 further includes a second pair of opposing sidewalls 20a, 20b that are connected laterally (side-by-side) between the lateral edges of the sidewalls 16a, 16b at lower portions thereof to form a box-like shape defining a void space 22 within the body 12 and an outer perimeter that surrounds the void space. The head 14 includes a planar top surface 24 and a pair of opposite flanges 26 that extend beyond the perimeter of the sidewalls. Outer ends of the flanges 26 each include a portion that is folded under the top surface 20 of the head 14. Although the head 14, and particularly the flanges of the head, is shown as including these two different levels, one above the other, the head may be formed of a single level sheet and/or plate. Each of the sets of opposing sidewalls 16a, 16b and 20a, 20b are identical and thus include similar features, thus it should be understood that although only sidewalls 16a and 20a are visible in FIG. 1, sidewall 16b is identical to sidewall 16a, and sidewall 20a is identical to sidewall 20b. The sidewalls define a pair of opposite slots 28 that are located above the sidewalls 20a and 20b and between the lateral edges of the sidewalls 20a, 20b. An elastic and resilient pre-assembly clip 30 extends from each of the two sidewalls 16a, 16b, the pre-assembly clips 30 extending outwardly from the sidewalls 16a, 16b and in opposite directions from each other. The body 12 further includes a pair of displacement control elements 32 that are connected to the flanges 26 of the head 14 and that extend downwardly from the head within the void space 22 of the body. The displacement control elements 32 each includes a ramp surface 34, and a guide surface 36 extends inwardly and upwardly from the ramp surface 34.

A receiving hole 38 is formed in the head 14, generally in a central location of the head. One or more prongs 40 may extend from the top surface 24 of the head 14 into the receiving hole 38, the prongs 40 provide a combined guiding surface and retention feature. An actuator 42 is inserted into and retained at the receiving hole 38. In this embodiment, the actuator 42 is in the form of a leadscrew including a screwhead 44, a threaded shaft 46 extending from the head, and an annular flange 48 between the screwhead and the threaded shaft. The annular flange 48 contacts the top surface 24 of the head 14, and the threaded shaft 46 includes an annular tab 50 that together with the prongs 40 prevents the actuator 42 from being removed from the receiving hole 38. The threaded shaft 46 of the actuator 42 contacts the prongs 40 and the guide surfaces 36 of the body 12, all these surfaces guiding the actuator 42 in a longitudinal, axial direction.

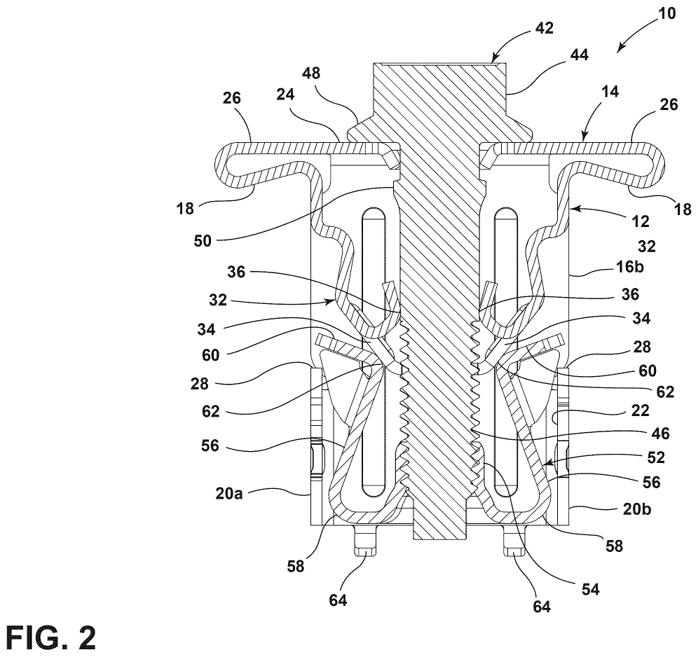

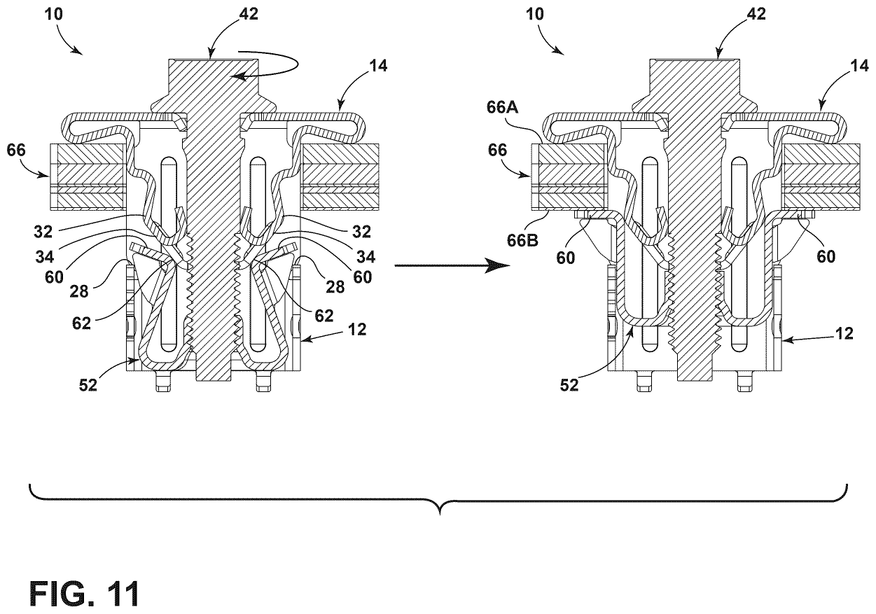

A carrier 52 is disposed within the void space 22 of the body 12, generally in a lower portion of the body adjacent all four sidewalls 16a, 16b, 20a, 20b. The carrier 52 includes a threaded collar 54 that functions as a nut and that is engaged with the threaded shaft 46 of the actuator 42. As such, the actuator 42 is a linear actuator that drives and controls the movement of the carrier in a linear, longitudinal direction within the void space of the body as described in greater detail below. The carrier 52 further includes a pair of control arms 56 that are each connected to the threaded collar 54 by resilient portion 58 in the form an angular bend of material. Each of the control arms 56 terminates in a retention clamp 60 that are generally disposed at or adjacent the slots 28 in the body 12. Each retention clamp 60 includes a contact surface 62 that contacts a respective one of the ramp surfaces 34 of the displacement control elements 32. Angular rotation of the actuator 42 moves the carrier 52 between a first position (e.g., see FIG. 2) in which the retention clamps 60 are retracted within the void space 22 of the body 12 and a second position (e.g., see FIG. 11) in which the retention clamps extend outwardly through the slots 28 in the body 12. The actuator 42 is reversibly operable to freely move the carrier 52 from the first position to the second position and from the second position back to the first position.

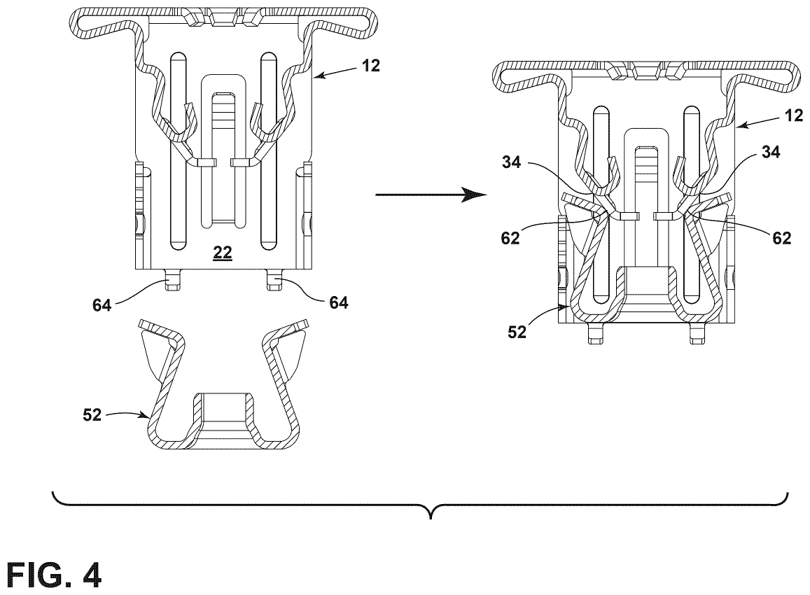

Turning to FIGS. 4-8, to assemble the fastener 10, the carrier 52 is inserted through an opening in the bottom of the body 12 that provides access to the void space 22. The carrier 52 is inserted so that it is completely within the void space 22, and small tongues 64 are bent inward to keep the carrier 52 from sliding out of the body 12 (prior to coupling with the actuator 42). In this inserted disposition, the contact surfaces 62 of the carrier 52 contact and engage the ramp surfaces 34 of the body 12. Next, the actuator 42 in the form of the leadscrew is inserted by a first translation into the receiving hole 38 in the head 14 until the terminal end of the threaded shaft 46 contacts the threaded collar 54 of the carrier 52. The prongs 40 at the receiving hole 38 and the guide surfaces 36 of the displacement control elements 32 aid in aligning and guiding the threaded shaft 46 as it moves axially through the void space 22. In this disposition, the annular tab 50 contacts the outer surface of the prongs 40 at the receiving hole 38. To engage the actuator 42 with the threaded collar 54 of the carrier 52, the actuator is rotated (moved in an angular direction) to screw the actuator into the carrier. The actuator can be rotated until the annular flange 48 contacts the top surface 24 of the head 14. During this rotational movement, the prongs 40 are bent slightly outward by the annular tab 50 of the actuator 42 until the annular tab passes by the prongs, at which point the prongs relax and rest within a groove 63 between the annular tab 50 and the annular flange 48. The actuator 42 is thus held in an axial orientation within the body 12, and the fastener 10 is ready for use.

The body 12, the actuator 42, and the carrier 52 form a unitary assembly in which all of the components of the fastener 10 are permanently held together in one unit piece. These parts of the fastener 10 are preferably formed of metal, by optionally may be constructed from a variety of materials including metals, polymers, composites, and combinations thereof. Further, the parts need not necessarily be all constructed from the same material. The body 12 can be a stamped metal part, such as a plate or sheet, that is manipulated and configured to include a variety of three-dimensional contours and aspects as shown. The same may also be true of the carrier 52.

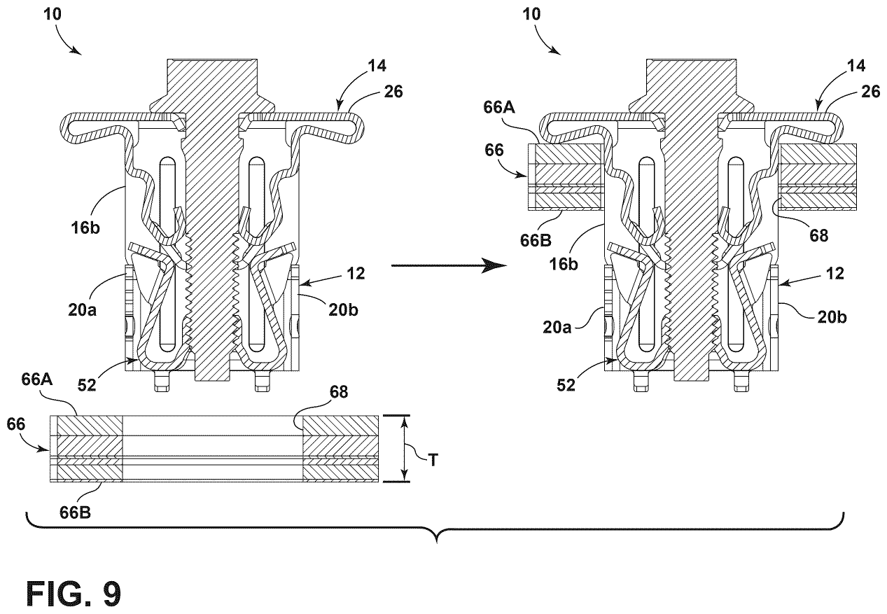

Turning now to FIGS. 9-15, the fastener 10 can be used to attach a component (not shown) to a panel 66 which optionally can define an aperture 68 bounded by a perimeter. As used herein, a panel can refer to any type of substrate, and need not be a flat, planar or sheet-like material, and can include three-dimensional parts or assemblies. The panel 66 shown in the drawings, however, can be of a generally flat configuration with a thickness T extending from an exterior or A side 66A of the substrate or panel to an interior of B side 66B of the panel 66. The panel can be any type of interior or exterior panel used, for example in vehicles, equipment, machines, or other products or assemblies. For example, the panel can be in the form of an interior or exterior trim or structural panel of a vehicle, such as an automobile. In the setting described herein, the panel may particularly be a portion of a vehicle to which an airbag is mounted via the fastener 10. It should be understood, however, that the fastener is not limited to this application and may be applied to other applications, such as fastening one panel to another panel or fastening a panel to an extruded profile, or even other applications requiring one part (not necessarily a panel) to be fastened to another part (not necessarily a panel), or three or more elements to be fastened together. As such, the “panel” may be a component that is mounted on another “panel” that is a metal or plastic plate, and further there may be another third “panel” (not shown in the drawings) that is the body of a vehicle. Thus, the “panels” may be planar members, or may be other elements or components that may or may not have planar portions.

To install the fastener 10 on the panel 66, the fastener is first preassembled in the panel by inserting the sidewalls 16a, 16b, 20a, 20b through the aperture 68 in the panel 66 until the head 14 of the fastener 10 is generally adjacent the aperture 68. The fastener 10 may be preassembled in the panel at an earlier time and location, or may be inserted into the panel just at the time of use in fastening two or more elements together. In this disposition the flanges 26 of the head 14 extend beyond the perimeter of the aperture 68 and lower surfaces of the flanges contact the exterior side 66A of the panel 66. Also, the pre-assembly clips 30, which are pressed inwardly as the body 12 is inserted into/through the aperture 68, are depressed when the body 12 is fully inserted, and these clips 30 contact the interior side 66B of the panel 66 to provide a minimal retention of the fastener 10 in the aperture 68. Next, the actuator 42 is rotated in a first angular direction. Since the actuator is fixed axially within the body 12, rotation of the actuator 42 moves the carrier 52 axially towards the head 14 and thus the panel 66 from the first position to the second position. As the carrier 52 moves towards the head 14, the retention clamps 60 are forced outward through the slots 28 due to the contact and sliding of the contact surface 62 of the retention clamps 60 against the ramp surfaces 34 of the displacement control elements 32. When the retention clamps 60 are fully extended in the second position, the retention clamps contact and are forced against the interior surface 66B of the panel 66 to compress the panel between the head 14 and the extended retention clamps 60 to thereby fix the fastener 10 in the panel 66 and to resist pull apart of the fastener from the assembly. In this configuration, the torque exerted by the actuator 42 provides the clamping force that maintains the fixing of the fastener 10 to the panel 66.

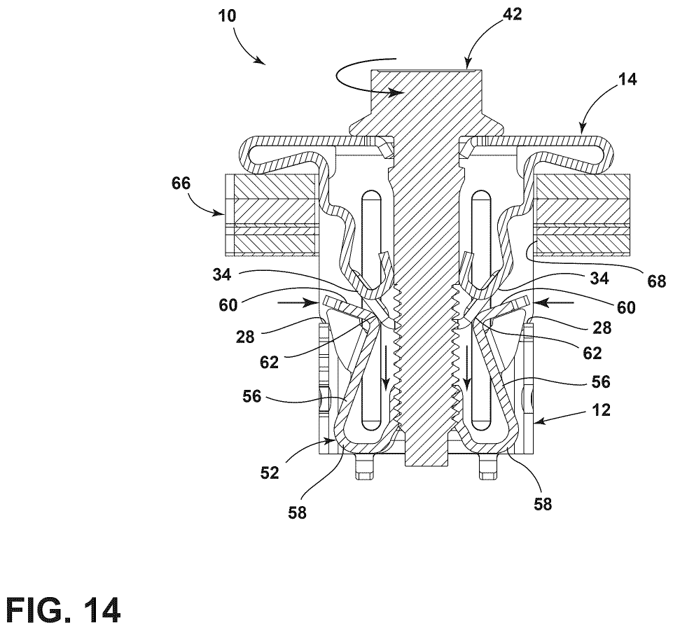

To dissemble the fastener 10 from the panel 66, such as when servicing the panel or any component mounted to the panel by the fastener, the actuator 42 is unscrewed by rotating the actuator in a second angular direction that is opposite the first angular direction to move the carrier 52 from the second position back to the first position. Particularly, as the actuator 42 is turned in the second angular direction, the carrier 52 moves away from the head 14, and the contact of the underside of the retention clamps 60 with the edges of the slots 28 forces the retention clamps back through the slots 28 and into the void space 22 within the body 12, as can be seen in FIG. 14. In addition, the movement of the contact surfaces 62 along the ramp surfaces 34 allow the resilient force of the resilient portions 58 of the control arms 56 also aides in drawing the retention clamps 60 back through the slots 28 and into the void space 22 within the body 12. However, due to any permanent deformation of the resilient portions 58, the resilient force alone may not be enough to move the retention clamps 60 completely inward. Once the retention clamps 60 are fully retracted, the fastener 10 may be removed from the panel aperture 68 by pulling it out of the aperture in a direction opposite to the insertion direction.

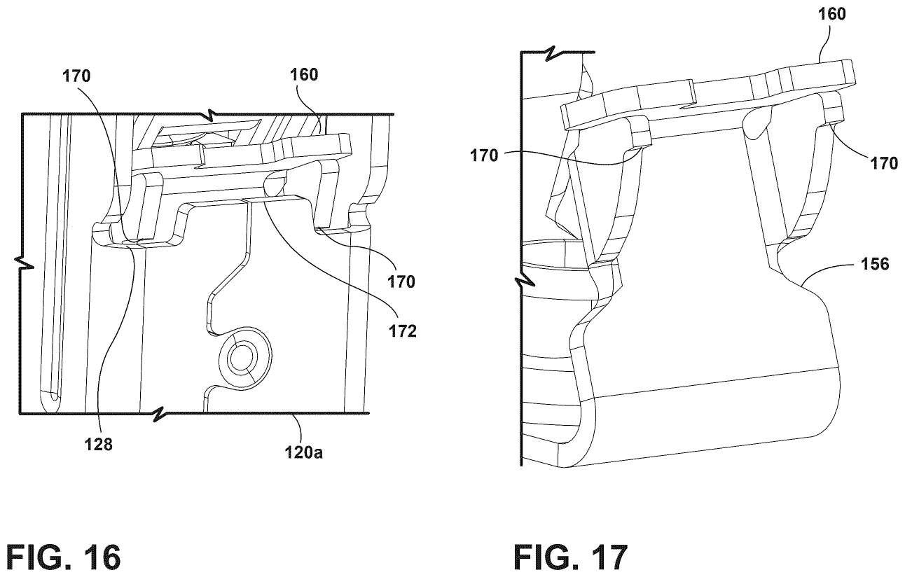

With reference to FIGS. 16 and 17, each control arm 156 may optionally include one or more stops 170 adjacent to the retention clamp 160. The stops 170 engage an edge of the slot 128 defined by the sidewall 120a on either side of tab or tongue 172. The stops 170 prevent the carrier from moving farther outward in the axial direction. For example, if the actuator is rotated too much in one angular direction such that the actuator becomes disengaged from the carrier, the stops 170 restrict the axial, outward movement of the carrier and keep the carrier from falling out of the internal void space within the body. Also, the stops 170 may eliminate the need to include the feature of the tongues 64 described above.

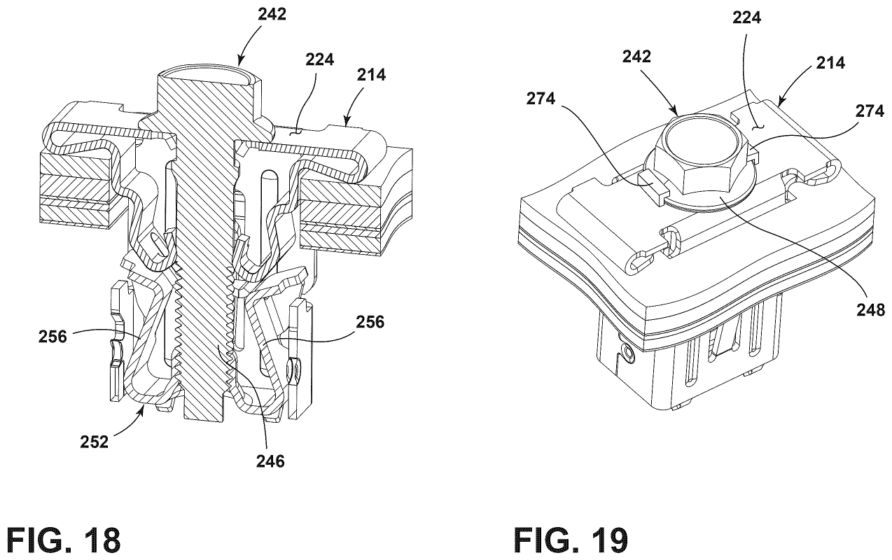

With reference to FIG. 18, in alternative embodiments the carrier 252 may include the threaded shaft 246, and the actuator 242 may be a nut that is engaged with on the threaded shaft of the carrier. In these embodiments, the actuator is retained on the outer surface 224 of the head 214. For example, as shown in FIG. 19, the annular flange 248 of the actuator 242 is retained on the head 214 by raised, angled projections 274 that define slits for receiving and restricting wayward movement of the actuator 242 in an axial direction. The projections 274 may be bent after the actuator 242 is installed, in order to retain the actuator 242, such as at an obtuse angle or alternatively a right angle. The projections 274 merely need to be bent enough to retain the actuator 242. Rotation of the actuator nut 242 turns the threaded shaft 242 and causes the threaded shaft to move outwardly from the actuator 242 and head 214, which in turn moves the control arms 256 of the carrier 252 towards the head 214.

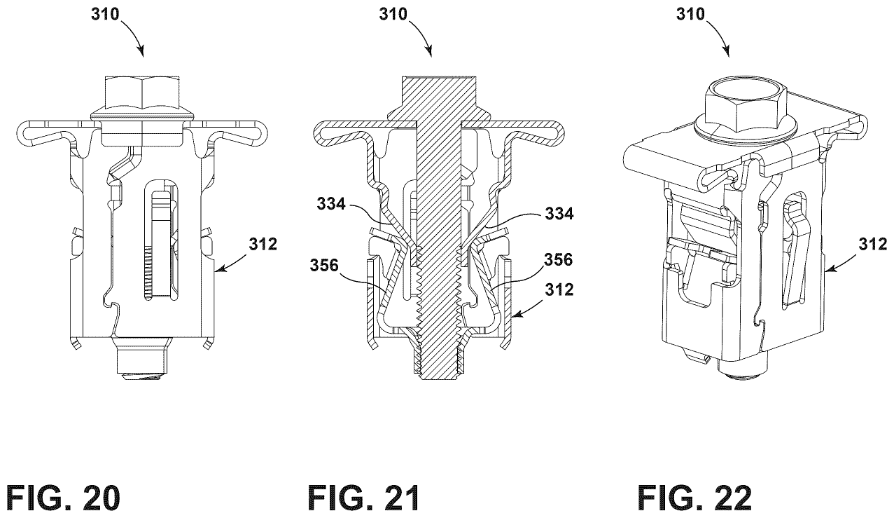

With reference to FIGS. 20-22, an alternative embodiment of the fastener 310 is shown in which the body 312 is aesthetically different than the first embodiment 10 and the control arms 356 and ramp surfaces 334 have a different configuration having the same function as in the first embodiment 10.

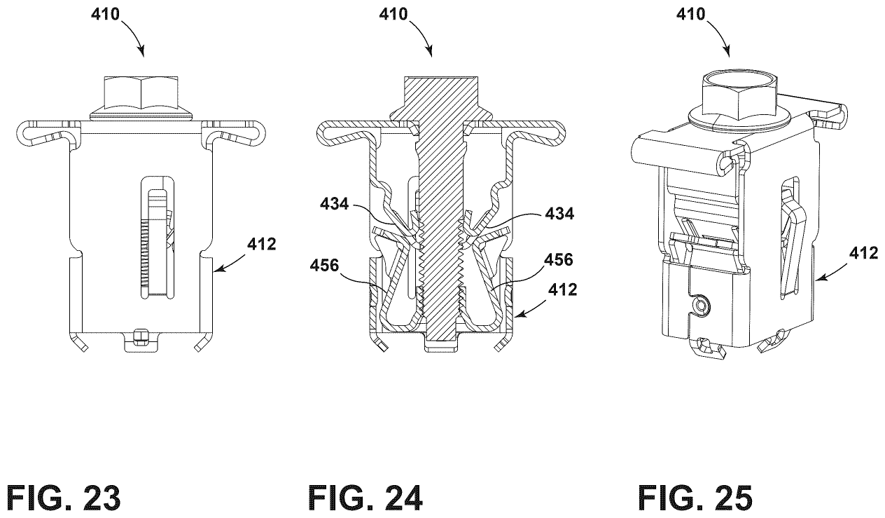

With reference to FIGS. 23-25, another alternative embodiment of the fastener 410 is shown in which the body 412 is aesthetically different than the first embodiment 10 and the control arms 456 and ramp surfaces 434 have yet another configuration having the same function as in the first embodiment 10.

Further, in other embodiments not shown, the pre-assembly clips may extend down from near the head towards the lower end of the body, rather than from near the lower end of the body towards the head as shown. Also, the contact between the control arms of the carrier and the ramp surfaces of the body may be reversed, i.e., flip-flopped.

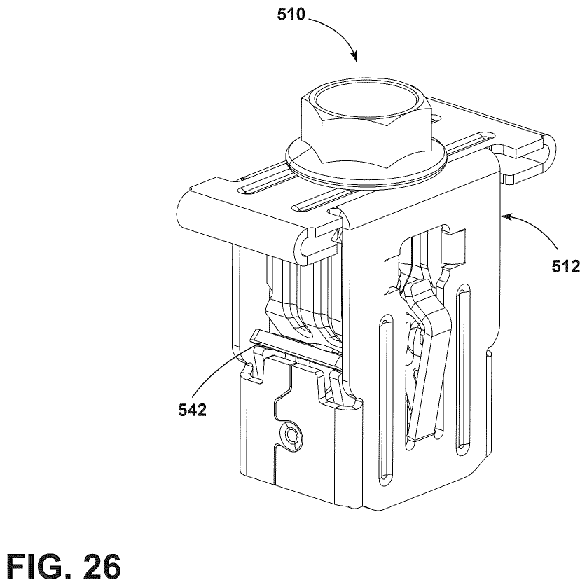

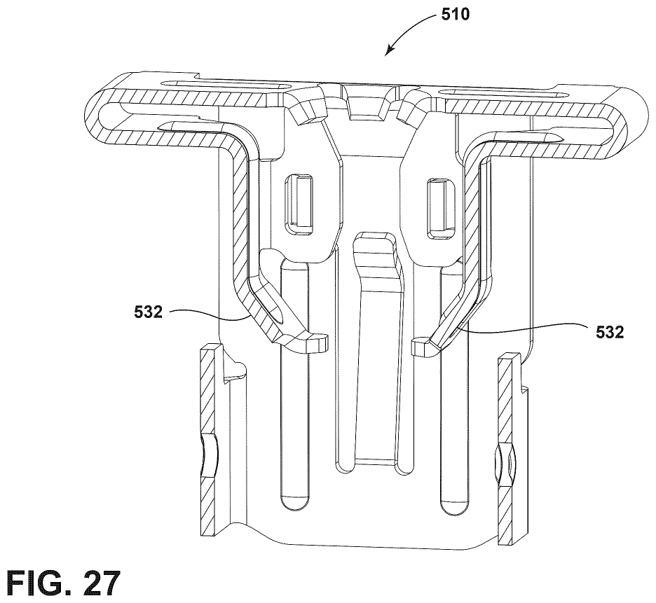

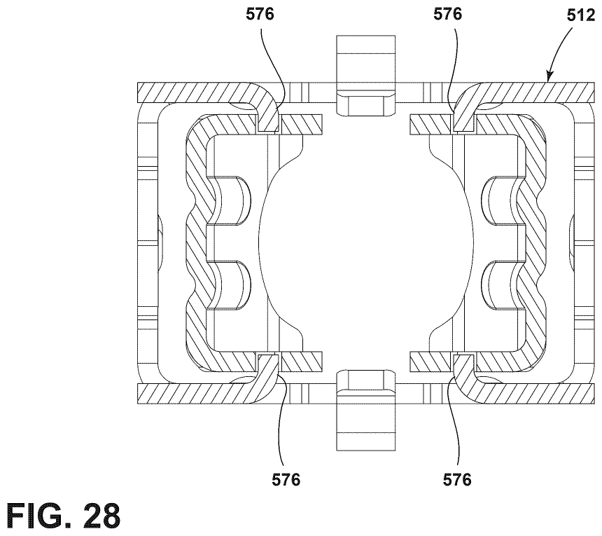

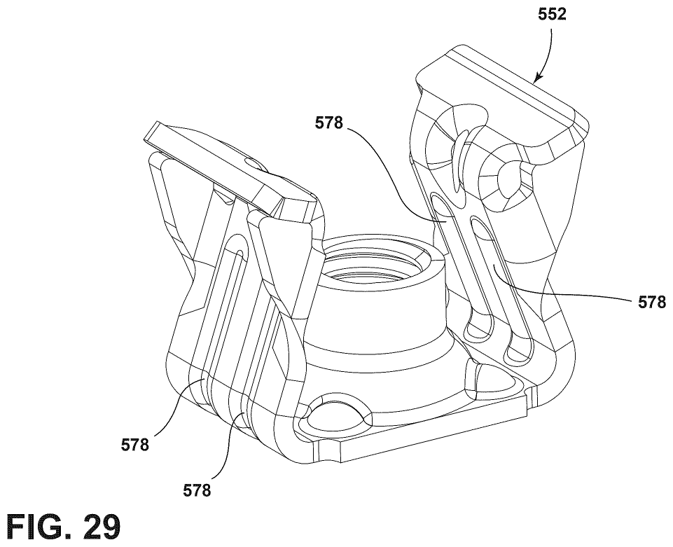

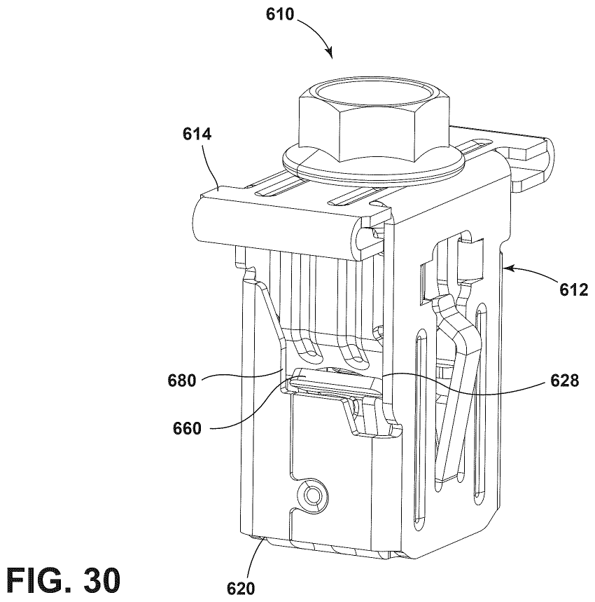

With reference next to FIGS. 26-29, in yet another embodiment of the fastener 510 the material bendings formed to construct the body 512 are altered. For example, as can be seen in FIG. 27, the displacement control elements 532 do not have the final bending that forms the guide surfaces 36 in the first embodiment of the fastener 10. Thus, the displacement control elements 532 do not have guide surfaces that contact the actuator 542, and there is no area of internal guiding for the actuator 542 during assembly. Also, as shown in FIG. 28, the body 512 includes internal self-reinforcement elements 576. Additionally, as shown in FIG. 29, the carrier 552 includes a plurality of reinforcing bends 578 that rigidify the structure of the carrier 552.

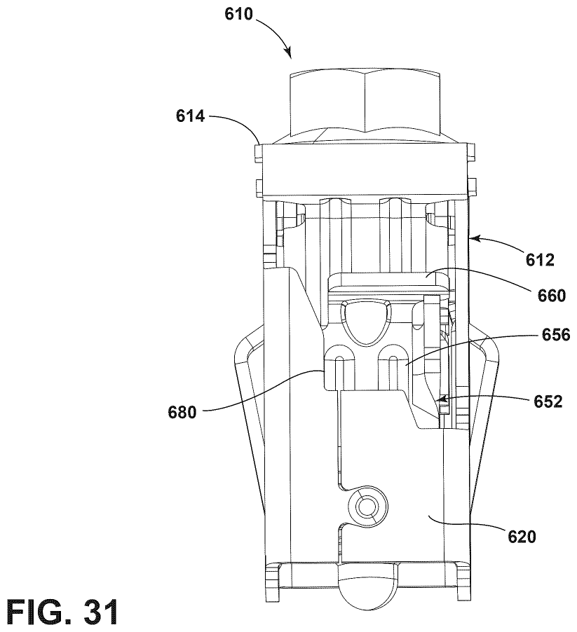

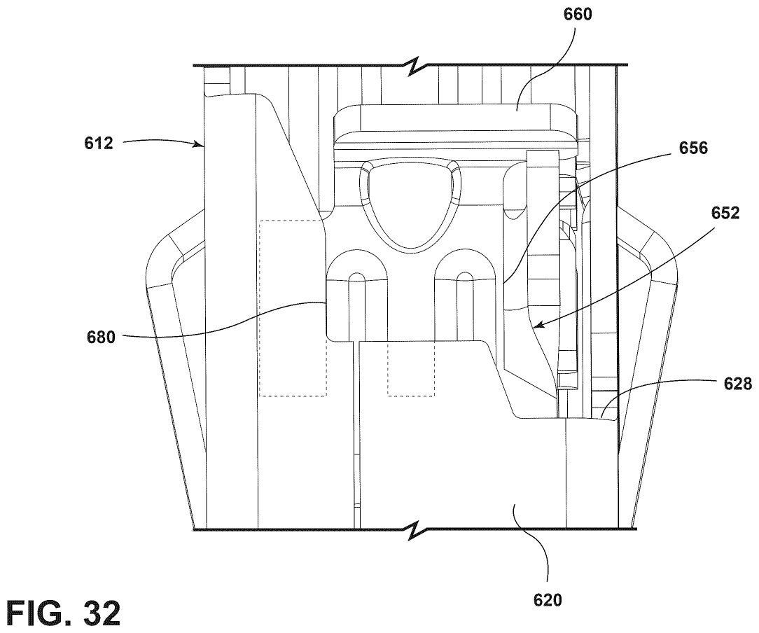

Turning next to FIGS. 30-32, in yet another embodiment of the fastener 610 the sidewalls 620 of the body 612 are asymmetric in the vicinity of the slots 628. More particularly, the edge of the sidewall 620 adjacent the slot 628 is stepped and includes a stop portion 680 that extends towards the head 614 of the body 612 and effectively covers a portion of the slot 628. The stop portion 680 aides to prevent the control arms 656 of the carrier 652 from undesirably splaying out under load as shown particularly in FIGS. 31 and 32 in which the retention clamps 660 are fully extended in the second position. In this position, the stop portion 680 overlaps the control arm 656 and prevents further outward movement of the control arm as can be seen best in FIG. 32.

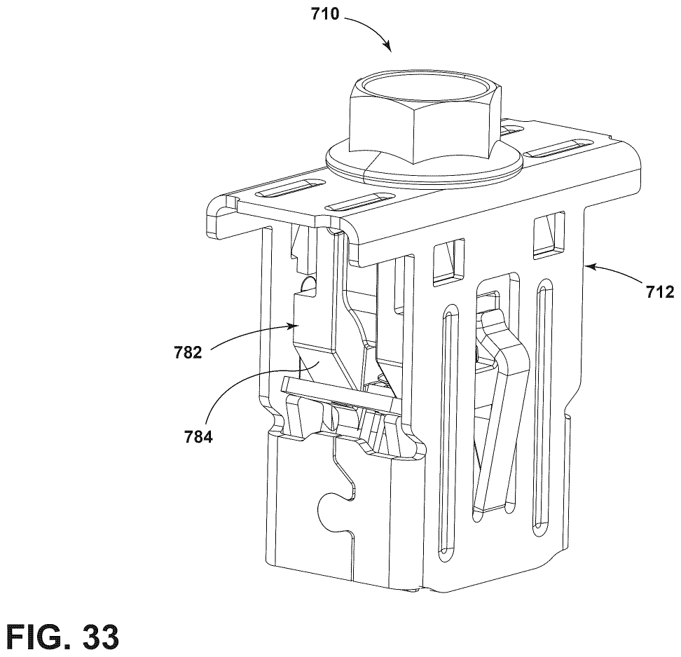

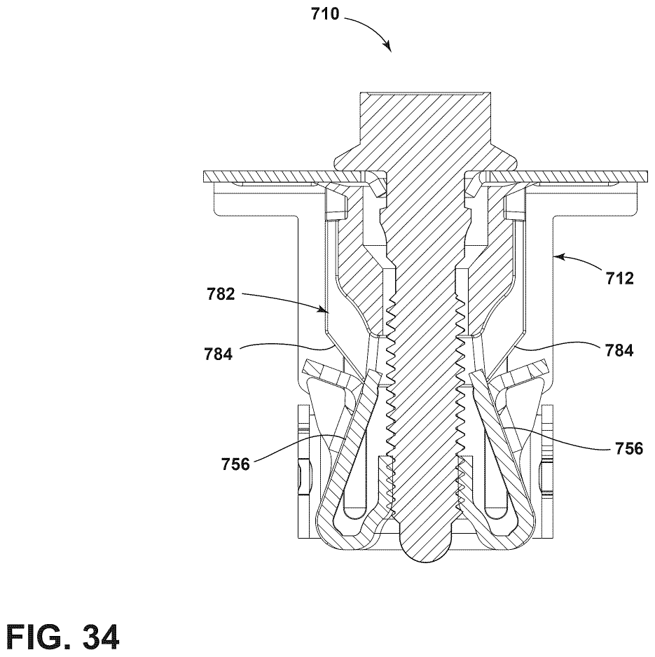

With reference finally to FIGS. 33 and 34, in yet another embodiment of the fastener 710 the internal construction of the body 712 is changed to eliminate material and simplify its construction. In place of this body material, an internal member 782 is added within the body 712. The internal member 782 includes the ramp surfaces 784 that are engageable with the control arms 756. As such, the body 712 does not include displacement control elements, in contrast to the first embodiment of the fastener 10 in which the displacement control elements of the body include the ramp surfaces. The internal member 782 may be formed of a plastic material, while the body may be formed of a metal material, and thereby the internal member may reduce the material cost of the fastener 710.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A fastener for attaching a component to a panel, the fastener comprising:
a body including a head, sidewalls extending longitudinally from the head and defining a void space within the body, and at least one slot formed in the sidewalls;
a receiving hole formed in the head;
a carrier disposed within the void space of the head, the carrier including at least one control arm corresponding to the at least one slot, each control arm terminating in a retention clamp;
an actuator retained at the receiving hole of the head, the actuator being engaged with the carrier;
wherein the actuator is reversibly operable to freely move the carrier between a first position in which each retention clamp is retracted within the void space of the body and a second position in which each retention clamp extends outwardly through one of the at least one slot in the body.

2. The fastener of claim 1, wherein the actuator is a leadscrew including a head and a threaded shaft, and the carrier includes a threaded collar that is mated with the threaded shaft.

3. The fastener of claim 2, wherein the threaded shaft extends through the receiving hole of the head and is retained within the void space of the body.

4. The fastener of claim 1, wherein the actuator is a threaded nut, and the carrier includes a threaded shaft that is mated with the threaded nut.

5. The fastener of claim 1, wherein the actuator is retained on an outer face surface of the head.

6. The fastener of claim 1, wherein rotational movement of the actuator is translated into linear movement of the carrier.

7. The fastener of claim 1, wherein the body includes at least one displacement control element cooperable with each control arm of the carrier.

8. The fastener of claim 7, wherein the displacement control elements each include a ramp surface that is engageable with a respective one of the control arms.

9. The fastener of claim 1, wherein each control arm includes a stop adjacent to the retention clamp, the stop restricting outward movement of the retention clamp through the slot.

10. The fastener of claim 1, wherein the body includes at least one pre-assembly clip extending from the sidewall.

11. The fastener of claim 10, wherein the at least one pre-assembly clip is a pair of opposite pre-assembly clips.

12. The fastener of claim 1, wherein the at least one slot formed in the sidewalls is a pair of opposite slots, and wherein the carrier includes a pair of said control arms, each control arm corresponding with one of said slots.

13. The fastener of claim 12, wherein the at least one displacement control element is a pair of displacement control elements, each coopearble with one of said control arms of the carrier.

14. The fastener of claim 1, wherein the head of the body includes a pair of opposite flanges extending laterally beyond a perimeter of the sidewalls.

15. The fastener of claim 1, wherein the body, the carrier, and the actuator form a unitary assembly.

16. A method of attaching a component to a panel including an aperture, the method comprising:
providing the fastener of claim 1;
inserting the sidewalls of the body through the aperture in the panel such that the head is adjacent the aperture; and
rotating the actuator in a first angular direction to move the carrier from the first position to the second position such that the retention clamps extend outwardly through the slots in the sidewalls and contact a surface of the panel opposite the head;
whereby the panel is compressed between the head and the extended retention clamps, the fastener is fixed to the panel about the aperture, and torque of the actuator provides a clamping force to maintain the fixing of fastener to the panel.

17. The method of claim 16, further including:
rotating the actuator in a second angular direction that is opposite the first angular direction to move the carrier from the second position to the first position such that the retention clamps are drawn back through the slots and into the void space within the sidewalls of the body; and
removing the body from the aperture in the panel;
whereby the fastener is reusable.
